(19) United States
(12) Patent Application Publication
(10) Pub. No.: US 2024/0211901 A1
(43) Pub. Date: Jun. 27, 2024

(54) BLOCKCHAIN HOSTED MACHINE LEARNING

(71) Applicant: VMware, Inc., Palo Alto, CA (US)

(72) Inventor: Sean James Huntley, Sydney (AU)

(21) Appl. No.: 18/087,428

(22) Filed: Dec. 22, 2022

(51) Int. Cl. G06Q 20/06; G06Q 20/36

(52) U.S. Cl. CPC G06Q 20/0655; G06Q 20/3676

(57) ABSTRACT

Disclosed are various embodiments for providing machine learning services to users of a blockchain network. A machine learning model can be hosted off the blockchain. A smart contract can then be deployed to the blockchain. The smart contract can include a reference to the machine learning model and weighted values that can be used by the machine learning model to make classifications. Successful machine learning models will tend to accumulate more cryptocurrency coins or tokens due to their continued use and execution, allowing for an orchestration service to identify successful sets of weighted values that can be adjusted as the basis for attempting to evolve better sets of weighted values for better performance by the machine learning model.

### BACKGROUND

The blockchain can be used as a host for publicly executable applications, commonly referred to as smart contracts. These smart contracts can make a host of services available to end-users in decentralized manner. The services provided by smart contracts often required that the end-user pay cryptocurrency coins or tokens in order to fund the execution of a function provided by the smart contract, with the amount of cryptocurrency coins or tokens required reflecting the amount of computational resources required.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a network environment according to various embodiments of the present disclosure.

FIG. 2 is a flowchart illustrating one example of functionality implemented as portions of an application executed in a computing environment in the network environment of FIG. 1 according to various embodiments of the present disclosure.

FIG. 3 is a flowchart illustrating one example of functionality implemented as portions of an application executed in a computing environment in the network environment of FIG. 1 according to various embodiments of the present disclosure.

FIG. 4 is a flowchart illustrating one example of functionality implemented as portions of an application executed in a computing environment in the network environment of FIG. 1 according to various embodiments of the present disclosure.

### DETAILED DESCRIPTION

Disclosed are various approaches for providing machine learning services to users of a blockchain network. A machine learning model can be hosted off the blockchain. A smart contract can then be deployed to the blockchain. The smart contract can include a reference to the machine learning model and weighted values that can be used by the machine learning model to make classifications. Successful machine learning models will tend to accumulate more cryptocurrency coins or tokens due to their continued use and execution, allowing for an orchestration service to identify successful sets of weighted values that can be adjusted as the basis for attempting to evolve better sets of weighted values for better performance by the machine learning model.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

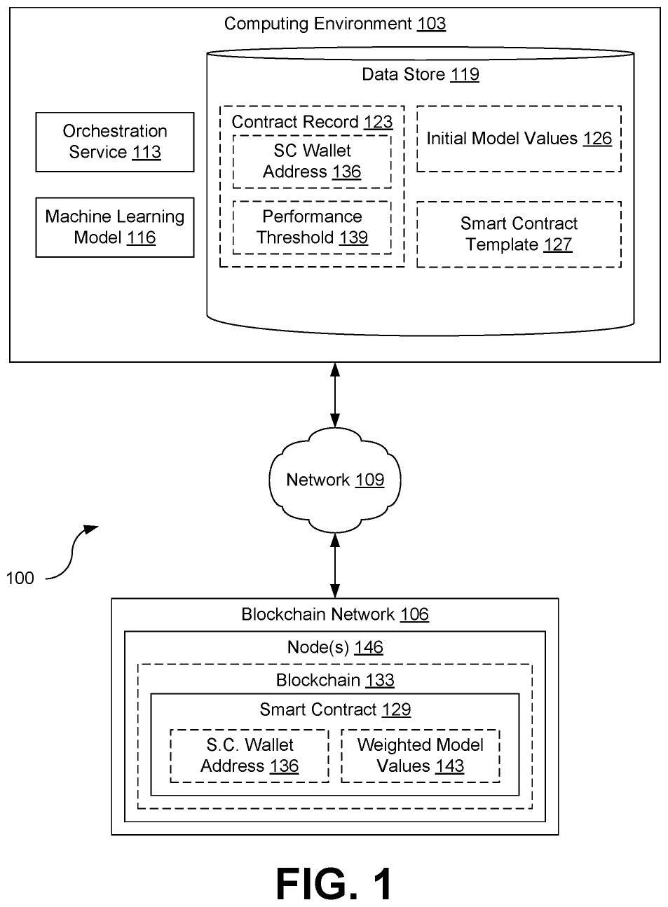

As illustrated in FIG. 1, shown is a network environment 100 according to various embodiments. The network environment 100 can include a computing environment 103 and a blockchain network 106, which can be in data communication with each other via a network 109. Although depicted separately for illustrative purposes, individual computing devices or software applications within the computing environment 103 could also be members of or participate in the blockchain network 106.

The network 109 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 109 can also include a combination of two or more networks 109. Examples of networks 109 can include the Internet, intranets, extranets, virtual private networks (VPNs), and similar networks.

The computing environment 103 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 103 can employ a plurality of computing devices that can be arranged in one or more server banks or computer banks or other arrangements. Such computing devices can be located in a single installation or can be distributed among many different geographical locations. For example, the computing environment 203 can include a plurality of computing devices that together can include a hosted computing resource, a grid computing resource or any other distributed computing arrangement. In some cases, the computing environment 203 can correspond to an elastic computing resource where the allotted capacity of processing, network, storage, or other computing-related resources can vary over time.

Various applications or other functionality can be executed in the computing environment 103. The components executed on the computing environment 103 include an orchestration service 113, a machine learning model 116, and other applications, services, processes, systems, engines, or functionality not discussed in detail herein.

Also, various data is stored in a data store 119 that is accessible to the computing environment 103. The data store 119 can be representative of a plurality of data stores 119, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 119 is associated with the operation of the various applications or functional entities described below. This data can include one or more contract records 123, one or more initial model values 126, a smart contract template 127, and potentially other data.

The contract records 123 can represent data tracked or recorded by the orchestration service 113 regarding individual smart contracts 129 hosted on the blockchain 133 of the blockchain network 106. Each smart contract 129 can have a respective contract record 123 for reference by the orchestration service 113. In order to differentiate contract records 123, each contract record 123 may include the smart contract wallet address 136 of its respective smart contract 129. The smart contract wallet address 136 can be used to uniquely identify one smart contract 129 with respect to another and, therefore, uniquely identify one contract record 123 with respect to another. Each contract record 123 can also include a performance threshold 139, which serves as a baseline for determining whether the respective smart contract 129 is operating successfully or acceptably. The performance threshold 139, for example, could represent a minimum value of cryptocurrency coins or tokens associated with the smart contract wallet address 136 needed in order for the orchestration service 113 to allow the smart contract 129 to continue to operate or for the orchestration service 113 to consider spawning, cloning, copying, or otherwise creating a derivate smart contract 129 that is based at least in part on the smart contract 129.

The initial model values 126 can represent initial or default values that can be supplied to or used as a basis for the weighted model values 143 that are initially supplied to a newly deployed smart contract 129. The initial model values 126 may be created manually or as the result of training the machine learning model 116 on a corpus of training data.

The smart contract template 127 can be used as a template for deploying new instances of the smart contract 129 to the blockchain network 106. The smart contract template 127 can represent a template that includes the functions, APIs, and other functionality used by an instance of the smart contract 129. The smart contract template 127 can be completed with various values, such as weighted values to be used for the machine learning model 116, and then deployed.

The orchestration service 113 can be executed to create, deploy, and monitor the performance of smart contracts 129 that provide access to the machine learning model 116. Based at least in part on the monitoring of individual smart contracts 129, the orchestration service 113 can determine which smart contracts 129 have sets of weighted model values 143 that are exceeding predefined performance thresholds 139 and use the sets of weighted model values 143 for new sets of weighted model values 143 for new smart contracts 129 in an attempt to improve the quality of the classifications made by the machine learning model 116.

The machine learning model 116 can be executed to classify inputs as being similar or dissimilar to sets of training data. Machine learning models 116 can include various types of neural networks, decision trees, linear regressions or regression analysis, etc. The machine learning model 116 may be provided with a set of weighted model values 143, which can configure how much weight the machine learning model 116 will give to various factors or criteria when making a classification.

In some implementations, the functionality of the orchestration service 113 and the functionality of the machine learning model(s) 116 could be combined into the same application or service. This could be done when a machine learning model 116 is configured to monitor the performance of other machine learning models 116 in order to evolve or improve the selection of the weighted model values 143 used by the machine learning model 116. In some instances, each machine learning model 116 could store its current configuration (e.g., current weighted model values 143) to the blockchain 133 at periodic intervals. Each machine learning model 116 could retrieve the current weighted model values 143 of other machine learning models 116 from the blockchain 133 in order to monitor the performance of other machine learning models 116 in order to evolve or improve the selection of the weighted model values 143 used by the machine learning model 116.

The blockchain network 106 represents a peer-to-peer network of nodes 146 that utilizes a consensus protocol to maintain an immutable, append only, eventually consistent data store such as a blockchain 133. In some implementations, the blockchain network 106 could be a permissioned blockchain network 106, where only authorized nodes 146 are permitted to join or participate in the blockchain network 106. Examples of permissioned blockchain networks include HYPERLEDGER FABRIC, QUOROM, and CORDA. In other implementations, the blockchain network 106 could be permissionless, where anyone is permitted to join the blockchain network 106. Examples of public or permissionless blockchain networks 106 include the BITCOIN network, the ETHEREUM network, the SOLANA network, etc.

Nodes 146 of the blockchain network 106 can represent computing devices and/or virtual machines that maintain a copy of the blockchain 133 and all transactions submitted to the blockchain network 106 for inclusion in the blockchain 133. In some blockchain networks 109, individual nodes 146 can perform specialized functions, such as creating or validating new blocks for the blockchain 133 (sometimes referred to as “mining”), storing a copy of the current state of the blockchain 133, responding to requests for the current state of the blockchain 133, etc. In other blockchain networks 106, one or more of these functions to be performed by the same node 146.

The blockchain 133 can represent an immutable, append only, eventually consistent distributed data store maintained by a plurality of nodes 146 in a peer-to-peer network that maintain duplicate copies of data stored in the blockchain 133. The nodes 146 of the blockchain network 106 can use a variety of consensus protocols to coordinate the writing of data written to the blockchain 133. In order to store data to the blockchain 133, such as a record of a transaction of cryptocurrency coins or tokens between wallet addresses, users can pay cryptocurrency coins or tokens to one or more of the nodes 146 of the blockchain 133. New data is written to the blockchain 133 in the form of blocks, with each block including the cryptographic hash of the previous block in the blockchain 133, thereby preventing tampering or altering of records stored in the blockchain 133.

In some implementations, a smart contract 129 can be hosted on the blockchain 133. A smart contract can represent executable computer code that can be executed by a node 146 of the blockchain network 106. In many implementations, the smart contract 129 can expose one or more functions that can be called by any user or by a limited set of users. To execute one or more functions of a smart contract 129, an application can submit a request to a node 146 of the blockchain network 106 to execute the function. The node 146 can then execute the function and store the result to the blockchain 133. Nodes 146 may charge fees in the form of cryptocurrency coins or tokens to execute a function and store the output, with more complicated or extensive functions requiring larger fees. An example of this implementation is the ETHEREUM blockchain network, where users can pay fees, referred to as “gas,” in order to have a node of the ETHEREUM blockchain network execute the function and store the result to the ETHEREUM blockchain. Additionally, the more “gas” a user pays, the more quickly the function will be executed, and its results committed to the ETHEREUM blockchain.

The smart contract 129 can be used to provide access to the machine learning model 116 or to execute code that uses or relies upon the machine learning model 116. For examples, in some instances, the smart contract 129 could receive classification requests from other applications or third-parties, which could be forwarded to the machine learning model 116. In these implementations, the smart contract 129 could receive the classification from the machine learning model 116 and return it to the requesting application or third-party. In other instances, the smart contract 129 could be self-executing, and make requests of the machine learning model 116. In these instances, the smart contract 129 could determine whether it should perform an action based at least in part on the classification or prediction provided by the machine learning model 116.

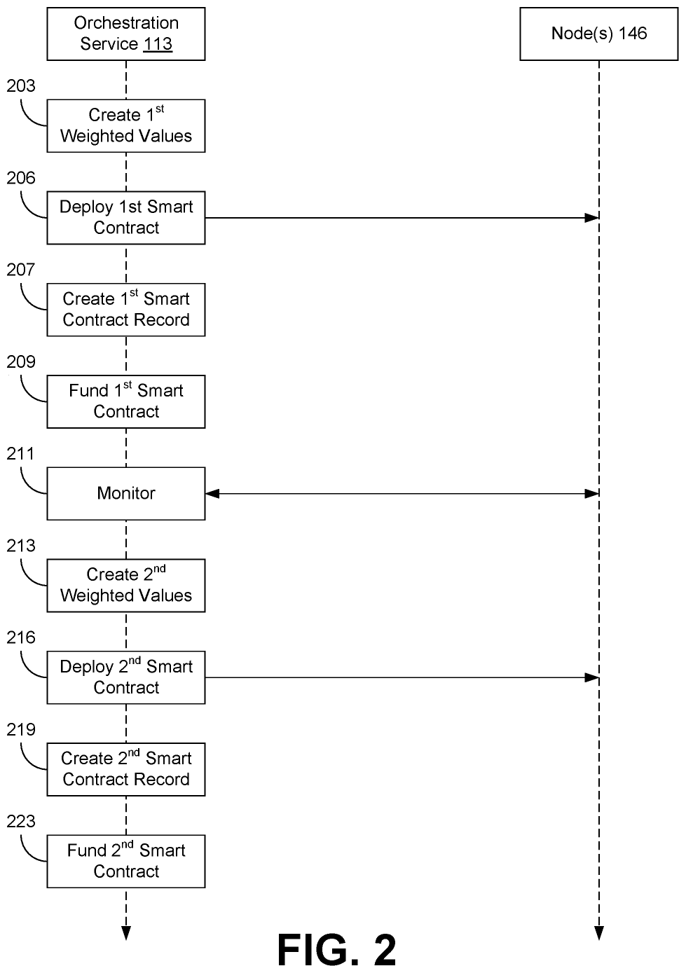

Referring next to FIG. 2, shown is a flowchart that provides one example of the operation of a portion of the orchestration service 113. The flowchart of FIG. 2 provides merely an example of the many different types of functional arrangements that can be employed to implement the operation of the depicted portion of the orchestration service 113. As an alternative, the flowchart of FIG. 2 can be viewed as depicting an example of elements of a method implemented within the network environment 100.

Beginning with block 203, the orchestration service 113 can create or generate one or more weighted model values 143 for the use by a new instance of a smart contract 129. The weighted model values 143 can be created in a variety of ways. For example, the weighted model values 143 could be copies of, or copied from, the initial model values 126. As another example, the weighted model values 143 could be based at least in part the initial model values 126. For instances, the orchestration service 113 could randomly modify one or more of the initial model values 126 to generate the weighted model values 143 for the smart contract 129. Alternatively, the weighted model values 143 could be copies of, or copied from the weighted model values 143 of another smart contract 129 that has already been deployed to the blockchain network 106. As another example, the weighted model value 143 could be based at least in part on the weighted model values 143 of another smart contract 129. In these examples, the orchestration service 113 could randomly modify one or more of the weighted model values 143 of an already deployed smart contract 129 to generate the weighted model values 143 for the new instance of the smart contract 129.

Then, at block 206, the orchestration service 113 can deploy the new instance of the smart contract 129 to the blockchain network 106. For example, the orchestration service 113 could add the weighted model values 146 created or generated at block 203 to a smart contract template 127 to generate a new smart contract 129. The new smart contract 129 could then be deployed to the blockchain network 106, for example, by providing a copy of the new smart contract 129 to a node 146 of the blockchain network 106, which then propagates the new smart contract 129 throughout the blockchain network 106. Some blockchain networks 106 may require payment of cryptocurrency coins or tokens in order for a new instance of the smart contact 129 to be deployed. In these implementations, the orchestration service 113 could pay the transaction fee using cryptocurrency coins or tokens from a wallet address under the control of the orchestration service 113. Moreover, a smart contract wallet address 136 could be assigned to the smart contract 129 by the blockchain network 106 in response to deployment of the smart contract 129. The smart contract wallet address 136 could be returned to the orchestration service 113 in response to successful deployment of the smart contract 129.

Once deployed, the orchestration service 113 can create a contract record 123 at block 207 in order to store data about the smart contract 129 deployed at block 206. The contract record 123 can include the smart contract wallet address 136 of the smart contract 129, which could have been assigned by the blockchain network 106 to the smart contract 129 at block 206 as part of the deployment process. A performance threshold 139 can also be stored in the contract record 123. The performance threshold 139 could be a default value or threshold, or one that is provided by a user at the time the smart contract 129 is created or deployed.

Proceeding to block 209, the orchestration service 113 can fund the smart contract 129 with an initial amount of cryptocurrency coins or tokens. In order for a smart contract 129 to execute a function, the smart contract 129 may be required to pay cryptocurrency transaction fees to the blockchain network 106. Accordingly, once the smart contract wallet address 136 is assigned to the smart contract 129 by the blockchain network 106 after the smart contract 129 is deployed, the orchestration service 113 could transfer cryptocurrency funds or tokens from a wallet address under the control of the orchestration service 113 to the wallet address of the smart contract 129.

Once funded, the smart contract 129 can begin execution in one of several ways. In some instances, the orchestration service 113 could invoke or call an API function provided by the smart contract 129 to begin execution. The orchestration service 113 could invoke or call the API function in response to completion of the funding of the smart contract 129. In other instances, the smart contract 129 could remain on the blockchain network 106 until execution is initiated by a third-party.

Next, at block 211, the orchestration service 113 can monitor the performance of the smart contract 129. For example, the orchestration service 113 could send a query to a node 146 of the blockchain network 106 for the cryptocurrency coin or token balance associated with the smart contract wallet address 136 of the smart contract 129 at periodic intervals. If the cryptocurrency coin or token balance meets or exceeds the performance threshold 139 specified in the contract record 123 for the smart contract 129, then the orchestration service 113 could determine that the smart contract 129 is using a set of weighted model values 143 for the machine learning model 116 which are performing as desired. Likewise, if the cryptocurrency coin or token balance fails to meet or exceed the performance threshold 139, then the orchestration service 113 could determine that the smart contract 129 is using a set of weighted model values 143 which are not performing as desired. The process can proceed to block 213 if the cryptocurrency coin or token balance meets or exceeds the performance threshold 139. Otherwise, the process will continue to periodically monitor the smart contract 129 until the cryptocurrency coin or token balance meets or exceeds the performance threshold 139. If the cryptocurrency coin or token balance reaches a zero balance or an effectively zero balance, the orchestration service 113 could stop monitoring the smart contact 129 because it no longer has sufficient cryptocurrency coins or tokens to fund itself and its continued execution.

As another example, the smart contract 129 could include a variable that could be used to track or monitor the performance of the smart contract 129. In these instances, the orchestration service 113 could query the value of the variable of the smart contract 129. If the value of the variable meets or exceeds the performance threshold 139, then the orchestration service 113 could determine that the smart contract 129 is using a set of weighted model values 143 for the machine learning model 116 which are performing as desired. Likewise, if the value of the variable fails to meet or exceed the performance threshold 139, then the orchestration service 113 could determine that the smart contract 129 is using a set of weighted model values 143 which are not performing as desired. The process can proceed to block 213 if the value of the variable meets or exceeds the performance threshold 139. Otherwise, the process will continue to periodically monitor the smart contract 129 until the value of the variable meets or exceeds the performance threshold 139.

Subsequently, at block 213, the orchestration service 113 can create a second set of weighted model values 143 for a second smart contract 129. The second set of weighted model values 143 could be created using a variety of approaches. For example, the weighted model values 143 created at block 203 could be copied by the orchestration service 113, and one or more of the values in these weighted model values 143 could be randomly adjusted by the orchestration service 113 in order to try and evolve or otherwise create an improved set of weighted model values 143 for the second smart contract 129 to use with the machine learning model 116. As another example, the weighted model values 143 created at block 203 could be copied, and additional weighted model values 143 associated with additional machine learning models 116 of additional smart contracts 129 could be analyzed for performance. One or more of the weighted model values 143 of the additional machine learning model 116 could be selected for inclusion in or replacement of the copied set of weighted model values 143 to provide for cross-pollination of potentially optimal weighted model values 143 of higher performing machine learning models 116.

Moving on to block 216, the orchestration service 113 can deploy the second smart contract 129 to the blockchain network 106. For example, the orchestration service 113 could add the weighted model values 146 created or generated at block 213 to a smart contract template 127 to generate the second smart contract 129. The second smart contract 129 could then be deployed to the blockchain network 106, for example, by providing a copy of the second smart contract 129 to a node 146 of the blockchain network 106, which then propagates the second smart contract 129 throughout the blockchain network 106. Some blockchain networks 106 may require payment of cryptocurrency coins or tokens in order for the second smart contact 129 to be deployed. In these implementations, the orchestration service 113 could pay the transaction fee using cryptocurrency coins or tokens from a wallet address under the control of the orchestration service 113. Moreover, a smart contract wallet address 136 could be assigned to the second smart contract 129 by the blockchain network 106 in response to deployment of the second smart contract 129. The smart contract wallet address 136 could be returned to the orchestration service 113 in response to successful deployment of the second smart contract 129.

Once deployed, the orchestration service 113 can create a contract record 123 at block 219 in order to store data about the second smart contract 129 deployed at block 216. The contract record 123 can include the smart contract wallet address 136 of the second smart contract 129, which could have been assigned by the blockchain network 106 to the second smart contract 129 at block 216 as part of the deployment process. A performance threshold 139 can also be stored in the contract record 123. The performance threshold 139 could be a default value or threshold, or one that is provided by a user at the time the second smart contract 129 is created or deployed.

Proceeding to block 223, the orchestration service 113 can fund the second smart contract 129 with an initial amount of cryptocurrency coins or tokens. In order for the second smart contract 129 to execute a function, the second smart contract 129 may be required to pay cryptocurrency transaction fees to the blockchain network 106. Accordingly, once the smart contract wallet address 136 is assigned to the second smart contract 129 by the blockchain network 106 after the second smart contract 129 is deployed, the orchestration service 113 could transfer cryptocurrency funds or tokens from a wallet address under the control of the orchestration service 113 to the wallet address of the second smart contract 129.

Once funded, the second smart contract 129 can begin execution in one of several ways. In some instances, the orchestration service 113 could invoke or call an API function provided by the second smart contract 129 to begin execution. The orchestration service 113 could invoke or call the API function in response to completion of the funding of the second smart contract 129. In other instances, the second smart contract 129 could remain on the blockchain network 106 until execution is initiated by a third-party.

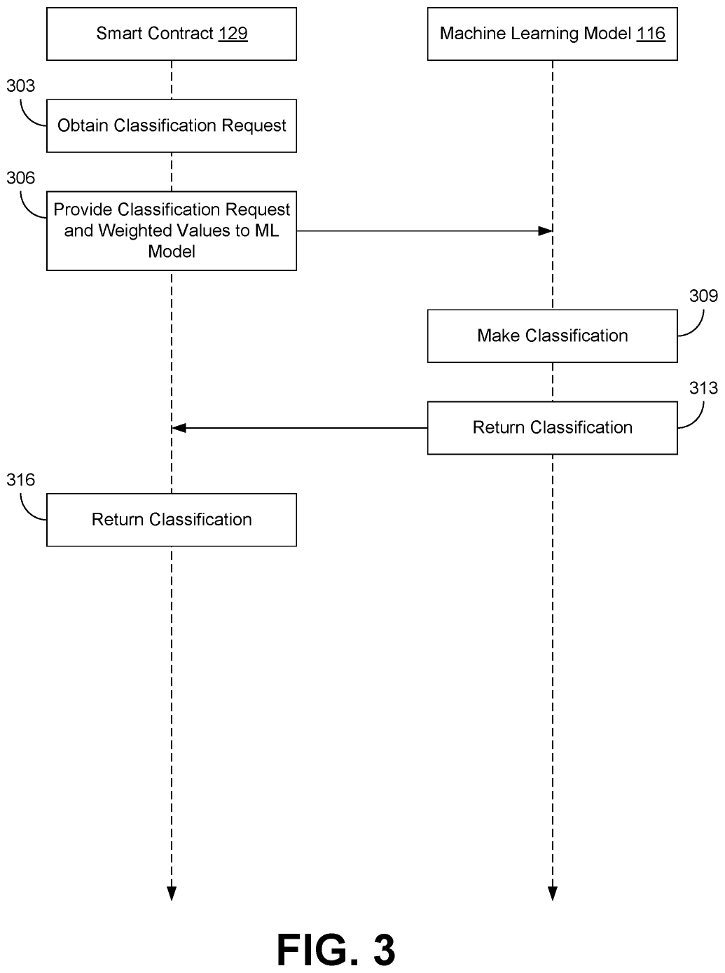

Referring next to FIG. 3, shown is a sequence diagram that provides one example of the interactions between the smart contract 129 and the machine learning model 116. The sequence diagram of FIG. 3 provides merely an example of the many different types of functional arrangements that can be employed to implement the operations of the depicted portions of the smart contract 129 and the machine learning model 116. As an alternative, the sequence diagram of FIG. 3 can be viewed as depicting an example of elements of a method implemented within the network environment 100.

Beginning with block 303, the smart contract 129 could obtain a classification request from a third-party or a separate application. A classification request is any task which requires a decision or classification to be made by the machine learning model 116. For example, a classification request for a trading program or bot could specify whether a proposed cryptocurrency trade is similar to previous, profitable cryptocurrency trades based at least in part on various data points or factors. If the machine learning model 116 determines that a trade is similar other trades that have been profitable, then the trade may ultimately be executed. In this example, the classification request could specify the types and amounts of cryptocurrency to be traded and a time window in which the trade would occur. Although cryptocurrency trading is used as an example of a classification request, other classification requests could be performed or evaluated by various embodiments of the present disclosure. For example, classification requests could be received for object detection or computer vision, pattern detection in various fields or applications, etc.

Classification requests could be obtained from a variety of sources. For example, a separate application or a third-party could provide the classification request to the smart contract 129. In these examples, the separate application or third-party could call a function provided by the smart contract 129 to pass the classification request to the smart contract 129, along with a sufficient amount of cryptocurrency coins or tokens to pay for the evaluation of the classification request by the machine learning model 116 and/or processing of the classification request by the smart contract 129 itself.

Next at block 306, the classification request and, in some instances, the weighted model values 143 of the smart contract 129 can be provided to the machine learning model 116 by the smart contract 129. In other instances, the machine learning model 116 could already be configured with the weighted model values 143 (e.g., due to a previous execution or configuration of the machine learning model 116). The network location of the machine learning model 116 may be stored in the smart contract 129 (e.g., as part of the creation and deployment process of FIG. 2). In some implementations, execution of the machine learning model 116 may require payment of cryptocurrency coins or tokens. In these implementations, the smart contract 129 could transfer an appropriate amount of cryptocurrency coins or tokens from the smart contract wallet address 136 to a wallet address on the blockchain network 106 associated with the machine learning model 116, which may also be stored in the smart contract 129 (e.g., as part of the creation and deployment process of FIG. 2).

Moving on to block 309, the machine learning model 116 could then use the weighted model values 143 to evaluate the classification request. For example, the machine learning model 116 could determine whether a proposed trade is similar other trades that have been profitable, and classify the proposed trade as likely or unlikely to be profitable. As another example, the machine learning model 116 could determine whether an object in an image is similar to other objects known to the machine learning model 116 (e.g., if an object in an image is a car or not a car) and classify the object in the image appropriately.

The classification could then ultimately be returned to the originator of the classification request. For example, at block 313, the classification request could return the resulting classification from the machine learning model 116 to the smart contract 129. The smart contract 129 could then return the classification to the originator or submitted of the classification request at block 316, where the classification could used as the basis for determining whether or not to perform some action.

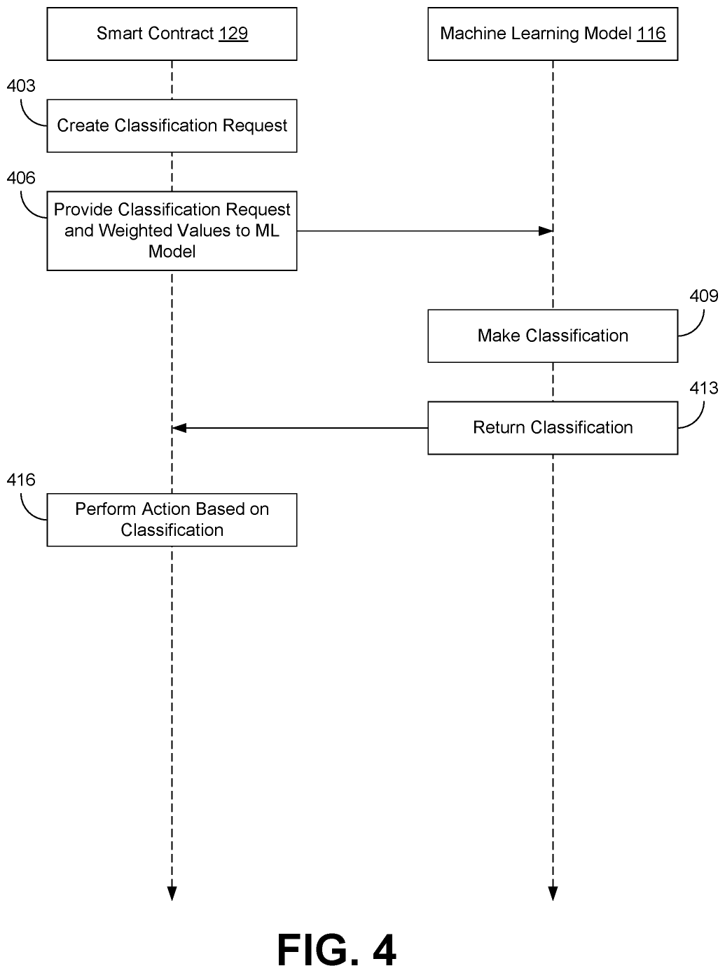

Referring next to FIG. 4, shown is a sequence diagram that provides one example of the interactions between the smart contract 129 and the machine learning model 116. The sequence diagram of FIG. 4 provides merely an example of the many different types of functional arrangements that can be employed to implement the operations of the depicted portions of the smart contract 129 and the machine learning model 116. As an alternative, the sequence diagram of FIG. 4 can be viewed as depicting an example of elements of a method implemented within the network environment 100.

Beginning with block 403, the smart contract 129 could generate a classification request for the machine learning model 116. This could occur when a smart contract 129 is self-executing. For example, a cryptocurrency trading application could be implemented as a smart contract 129, which periodically identifies potential trades based at least in part on predefined criteria or a predefined trading strategy. Accordingly, the smart contract 129 could create a classification request for each potential cryptocurrency trade.

Next at block 406, the classification request and the weighted model values 143 of the smart contract 129 can be provided to the machine learning model 116 by the smart contract 129. The network location of the machine learning model 116 may be stored in the smart contract 129 (e.g., as part of the creation and deployment process of FIG. 2). In some implementations, execution of the machine learning model 116 may require payment of cryptocurrency coins or tokens. In these implementations, the smart contract 129 could transfer an appropriate amount of cryptocurrency coins or tokens from the smart contract wallet address 136 to a wallet address on the blockchain network 106 associated with the machine learning model 116, which may also be stored in the smart contract 129 (e.g., as part of the creation and deployment process of FIG. 2).

Moving on to block 409, the machine learning model 116 could then use the weighted model values 143 to evaluate the classification request. For example, the machine learning model 116 could determine whether the proposed trade is similar other trades that have been profitable, and classify the proposed trade as likely or unlikely to be profitable.

Then, at block 413, the machine learning model 116 could return the resulting classification from the machine learning model 116 to the smart contract 129.

Subsequently, at block 416, the smart contract 129 could perform an action, or fail to perform an action, based on the resulting classification returned by the machine learning model 116. For example, if the smart contract 129 were implementing a cryptocurrency trading application, the smart contract 129 could determine whether or not to execute the proposed trade based at least in part on whether the machine learning model 116 had classified the proposed trade as similar to previously profitable trades. If the machine learning model 116 had classified the proposed trade as being similar to previously profitable trades, then the smart contract 129 execute the cryptocurrency trade at block 416 (e.g., by invoking a function provided by a decentralized finance (DeFi) smart contract to execute the cryptocurrency trade).

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
create a first plurality of weighted values for an off-chain machine learning model;
deploy a first smart contract to a blockchain network, the first smart contract comprising the first plurality of weighted values;
monitor a variable or an account balance associated with a wallet address of the first smart contract, the account balance acting as an indicator for the performance of the off-chain machine learning model using the first plurality of weighted values;
in response to the variable or the account balance of the smart contract meeting or exceeding a predefined threshold, create a second plurality of weighted values for the off-chain machine learning model; and
in response to the variable or the account balance of the first smart contract meeting or exceeding a predefined threshold, deploy a second smart contract to the blockchain network, the second smart contract comprising the second plurality of weighted values.

2. The system of claim 1, wherein the variable or the account balance is a first variable or a first account balance, and the machine-readable instructions, when executed by the processor, cause the computing device to at least:
monitor a second variable or a second account balance of the second smart contract, the second variable or the second account balance acting as an indicator for the performance of the off-chain machine learning model using the second plurality of weighted values;
in response to the second variable or the second account balance of the second smart contract meeting or exceeding the predefined threshold, create a third plurality of weighted values for the off-chain machine learning model; and
in response to the second variable or the second account balance of the second smart contract meeting or exceeding the predefined threshold, deploy a third smart contract to the blockchain network, the third smart contract comprising the third plurality of weighted values.

3. The system of claim 1, wherein the machine-readable instructions that cause the computing device to create the second plurality of weights, when executed by the processor, further cause the computing device to at least:
copy, from the first smart contract, a current state of the first plurality of weighted values; and
adjust at least one weighted value in the current state of the first plurality of weighted values copied from the first smart contract.

4. The system of claim 1, wherein the machine-readable instructions further cause the computing device to transfer a predefined amount of cryptocurrency coins or tokens to the wallet address associated with the first smart contract.

5. The system of claim 4, wherein the first smart contract is self-executing, and the machine-readable instructions further cause the computing device to at least initiate execution of the first smart contract in response to the transfer of the predefined amount of cryptocurrency coins or tokens to the wallet address associated with the first smart contract.

6. The system of claim 1, wherein the machine-readable instructions that cause the computing device to create the second plurality of weights, when executed by the processor, further cause the computing device to at least:
obtain, from the blockchain, a third plurality of weights associated with a second machine learning model; and
adjust at least one weighted value of the first plurality of weighted values based at least in part on the third plurality of weights associated with the second machine learning model.

7. The system of claim 1, wherein a network location of the machine learning model is stored in the first smart contract and the second smart contract.

8. A method, comprising:
creating a first plurality of weighted values for an off-chain machine learning model;
deploying a first smart contract to a blockchain network, the first smart contract comprising the first plurality of weighted values;
monitoring a variable or an account balance associated with a wallet address of the first smart contract, the variable or account balance acting as an indicator for the performance of the off-chain machine learning model using the first plurality of weighted values;
in response to the variable or the account balance of the smart contract meeting or exceeding a predefined threshold, creating a second plurality of weighted values for the off-chain machine learning model; and
in response to the variable or the account balance of the first smart contract meeting or exceeding a predefined threshold, deploying a second smart contract to the blockchain network, the second smart contract comprising the second plurality of weighted values.

9. The method of claim 8, wherein the variable is first variable, the account balance is a first account balance, and the method further comprises:
monitoring a second variable or a second account balance of the second smart contract, the second variable or the second account balance acting as an indicator for the performance of the off-chain machine learning model using the second plurality of weighted values;
in response to the second variable or the second account balance of the second smart contract meeting or exceeding the predefined threshold, creating a third plurality of weighted values for the off-chain machine learning model; and
in response to the second variable or the second account balance of the second smart contract meeting or exceeding the predefined threshold, deploying a third smart contract to the blockchain network, the third smart contract comprising the third plurality of weighted values.

10. The method of claim 8, wherein creating the second plurality of weights further comprises:
copying, from the first smart contract, a current state of the first plurality of weighted values; and
adjusting at least one weighted value in the current state of the first plurality of weighted values copied from the first smart contract.

11. The method of claim 8, further comprising transferring a predefined amount of cryptocurrency coins or tokens to the wallet address associated with the first smart contract.

12. The method of claim 11, wherein the first smart contract is self-executing, and the method further comprises initiating execution of the first smart contract in response to transferring the predefined amount of cryptocurrency coins or tokens to the wallet address associated with the first smart contract

13. The method of claim 8, wherein the off-chain machine learning model is a neural network or a decision tree.

14. The method of claim 8, wherein a network location of the machine learning model is stored in the first smart contract and the second smart contract.

15. A non-transitory, computer-readable medium, comprising machine-readable instructions that, when executed by a processor of a computing device, cause the computing device to at least:
create a first plurality of weighted values for an off-chain machine learning model;
deploy a first smart contract to a blockchain network, the first smart contract comprising the first plurality of weighted values;
monitor a variable or an account balance associated with a wallet address of the first smart contract, the variable or the account balance acting as an indicator for the performance of the off-chain machine learning model using the first plurality of weighted values;
in response to the variable or the account balance of the smart contract meeting or exceeding a predefined threshold, create a second plurality of weighted values for the off-chain machine learning model; and
in response to the variable or the account balance of the first smart contract meeting or exceeding a predefined threshold, deploy a second smart contract to the blockchain network, the second smart contract comprising the second plurality of weighted values.

16. The non-transitory, computer-readable medium of claim 15, wherein the variable is a first variable, the account balance is a first account balance, and the machine-readable instructions, when executed by the processor, cause the computing device to at least:
monitor a second variable or a second account balance of the second smart contract, the second variable or the second account balance acting as an indicator for the performance of the off-chain machine learning model using the second plurality of weighted values;
in response to the second variable or the second account balance of the second smart contract meeting or exceeding the predefined threshold, create a third plurality of weighted values for the off-chain machine learning model; and
in response to the second variable or the second account balance of the second smart contract meeting or exceeding the predefined threshold, deploy a third smart contract to the blockchain network, the third smart contract comprising the third plurality of weighted values.

17. The non-transitory, computer-readable medium of claim 15, wherein the machine-readable instructions that cause the computing device to create the second plurality of weights, when executed by the processor, further cause the computing device to at least:
copy, from the first smart contract, a current state of the first plurality of weighted values; and
adjust at least one weighted value in the current state of the first plurality of weighted values copied from the first smart contract.

18. The non-transitory, computer-readable medium of claim 15, wherein the machine-readable instructions further cause the computing device to transfer a predefined amount of cryptocurrency coins or tokens to the wallet address associated with the first smart contract.

19. The non-transitory, computer-readable medium of claim 18, wherein the first smart contract is self-executing, and the machine-readable instructions further cause the computing device to at least initiate execution of the first smart contract in response to the transfer of the predefined amount of cryptocurrency coins or tokens to the wallet address associated with the first smart contract.

20. The non-transitory, computer-readable medium of claim 15, wherein the off-chain machine learning model is a neural network or a decision tree.
